(19) United States
(12) Patent Application Publication
(10) Pub. No.: US 2015/0233170 A1
(43) Pub. Date: Aug. 20, 2015

(54) TILT AND TURN WINDOW SYSTEM HAVING DAMPER

(71) Applicant: LG HAUSYS, LTD., Seoul (KR)

(72) Inventors: Bo Ra Nam, Cheongju-si (KR); Byung Hoon Jeon, Cheongju-si (KR)

(21) Appl. No.: 14/373,859

(22) PCT Filed: Jan. 28, 2013
(86) PCT No.: PCT/KR2013/000654

§ 371 Date: Jul. 22, 2014

(30) Foreign Application Priority Data
Jan. 31, 2012 (KR) 10-2012-0009403

(51) Int. Cl. E06B 3/34; E05F 1/10; E05D 7/06; E05D 15/52; E05D 15/48

(52) U.S. Cl. CPC E06B 3/341; E05D 15/52; E05D 15/48; E05D 7/06; E05F 1/10; E05D 2015/487

(57) ABSTRACT

Disclosed is a tilt and turn window system having a damper, which can prevent each corner portion of a window frame from being damaged by shock generated when a window is closed on the window frame in a super high-rise building to which high wind pressure is applied. To this end, the T-T (Tilt & Turn) window system having a damper, includes a window frame; a window which is coupled to the window frame so as to be closed and opened in a T-T manner; and a damper which is disposed at at least one side of the window frame so as to be contacted with a surface of the window.

### TECHNICAL FIELD

The present invention relates to a tilt and turn window, and more particularly to a tilt and turn window system having a damper, which can prevent each corner portion of a window frame from being damaged by shock generated when a window is closed on the window frame in a super high-rise building to which high wind pressure is applied.

### BACKGROUND ART

Generally, a window system means various windows and doors which are respectively installed at an opened portion of a building, such as a window and a gate, in order to block off the inside of the building from the outside thereof. Herein, a window frame on which the window or door is supported is classified into a wood window frame and a metal window frame according to its material. But recently, the door and the window frame can be formed of a plastic material, and the window frame may be formed of a synthetic resin such as PVC.

Recently, a T-T (Tilt & Turn) window system which is rotated around one side or a lower end thereof has been proposed.

However, if the T-T window system is installed at a super high-rise building, the window may be rapidly closed on the window frame due to high wind pressure. In this case, each corner portion of the window frame may be damaged by shock generated when the window is closed on the window frame.

### DISCLOSURE OF INVENTION

### Technical Problem

An object of the present invention is to provide a T-T window system having a damper, which can absorb and relieve the shock generated when the window is closed on the window frame, thereby preventing each corner portion of the window frame from being damaged and thus securing safety.

### Solution to Problem

To achieve the object of the present invention, the present invention provides a T-T window system having a damper, including a window frame; a window which is coupled to the window frame so as to be closed and opened in a T-T manner; and a damper which is disposed at at least one side of the window frame so as to be contacted with a surface of the window.

Preferably, the damper includes a damper body in which a cylinder is provided at one side thereof; a damping shaft which is slidably inserted into the cylinder and of which exposed one end is formed with a contact surface; and an elastic spring which is disposed in the cylinder so as to elastically support the other end of the damping shaft.

Preferably, the damper body has a plurality of installation holes, and also the damper body is installed at one side of the window frame through a coupling member inserted into the installation hole.

Preferably, the damping shaft carries out a damping operation using oil pressure generated by sliding of the damping shaft.

Preferably, a gasket is provided at a surface of the window, which is contacted with the window frame, and the gasket is contacted with a contact surface of the damping shaft when the window is closed on the window frame.

Preferably, the contact surface of the damping shaft is formed of a soft rubber or silicon material.

Preferably, a protrusion is further provided at a lower surface of the damper body so as to be fixedly inserted and settled in a coupling groove formed in the window frame.

### Advantageous Effects of Invention

According to the present invention, the T-T window system having a damper can absorb and relieve the shock generated when the window is closed on the window frame, thereby preventing each corner portion of the window frame from being damaged and thus securing safety.

Further, since the T-T window system having a damper absorbs and relieves the shock generated when the window is closed on the window frame, it is possible to secure durability of the window system.

### BRIEF DESCRIPTION OF DRAWINGS

The above and other objects, features and advantages of the present invention will become apparent from the following description of preferred embodiments given in conjunction with the accompany drawings, in which:

FIG. 1 is a perspective view of a T-T (Tilt & Turn) window system having a damper according to the present invention.

FIG. 2 is a perspective view of the damper according to the present invention.

FIG. 3 is a cross-sectional view showing the inner structure of the damper according to the present invention.

FIG. 4 is a cross-sectional view showing that a window is closed in the T-T window system having a damper according to the present invention.

### DETAILED DESCRIPTION OF MAIN ELEMENTS

100: T-T window system having a damper
110: window frame
120: window
130: damper
131: damper body
132: damping shaft
133: elastic spring
140: gasket

### BEST MODE FOR CARRYING OUT THE INVENTION

Hereinafter, the embodiments of the present invention will be described in detail with reference to accompanying drawings.

Here, in each drawing, same reference numerals are used for the same component elements over the embodiments.

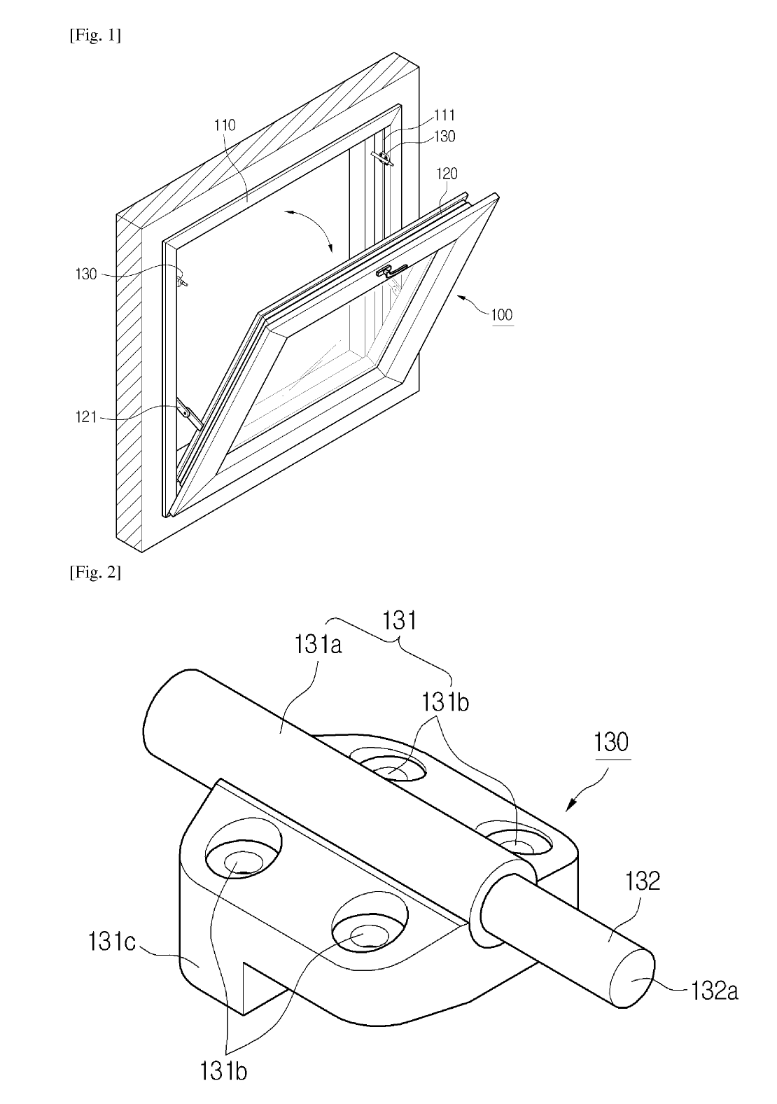

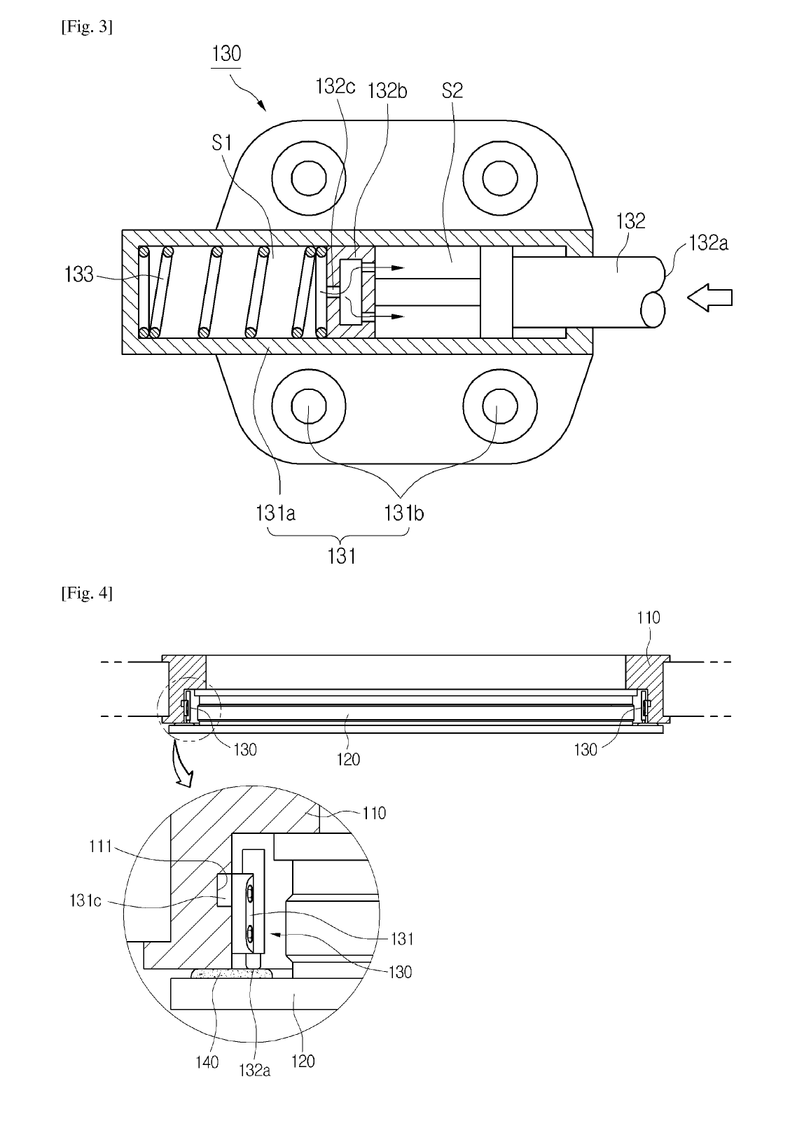

FIG. 1 is a perspective view of a T-T (Tilt & Turn) window system having a damper according to the present invention, FIG. 2 is a perspective view of the damper according to the present invention, and FIG. 3 is a cross-sectional view showing the inner structure of the damper according to the present invention.

As shown in FIGS. 1 and 2, the T-T window 100 having a damper according to the present invention includes a window frame 110, a window 120 which is coupled to the window frame 110 so as to be opened and closed in a T-T manner, and a damper 130 which is disposed at at least one side of the window frame 110 so as to be contacted with a surface of the window 120.

Hereinafter, the configuration of the present invention will be described detailedly.

The window 120 is rotatably coupled to one side or a lower end of the window frame 110 through a plurality of hinges so as to be opened and closed in the T-T manner. In this case, an opening angle of the window 120 is limited by at least one link member 121 which is hingably installed at one side of the window 120. Such structure of the window 120 basically prevents a child from approaching to a balustrade and thus prevents safety accident such as falling of the child from the balustrade.

The damper 130 functions to relieve shock generated when the window 120 is rapidly closed on the window frame 110 due to high wind pressure while the window 120 is opened and closed. Preferably, the damper 130 includes a damper body 131 which has a cylinder 131a and an installation hole 131b at one side thereof, and a damping shaft 132 which is slidably inserted into the cylinder 131a and of which exposed one end is formed with a contact surface 132a. In this case, the damper body 131 is coupled to one side of the window frame 110 through a coupling member (not shown) which is installed in the installation hole 131b, and the damping shaft 132 performs a damping operation using oil pressure while being slid in the cylinder 131a.

Referring to FIG. 3, the structure of the damper 130 is described more fully. Desired oil is filled in the cylinder 131a, and a piston 132b which divides internal space of the cylinder 131a is formed at the other end of the damping shaft 132 which is slidably inserted into the cylinder 131a.

In this case, at least one through-hole 132c is formed in the piston 132b so as to communicate the divided spaces S1 and S2 in the cylinder 131a, and the through-hole 132c has a smaller diameter than an inner diameter of the cylinder 131a. Therefore, if the damping shaft 132 is slide toward the other end thereof by shock power applied to the one end thereof, the oil filled in the cylinder 131a is flowed through the through-hole 132c from one space S1 to the other space S2 over a desired period of time. In other words, a sliding speed of the damping shaft 132 is delayed by the oil pressure, and thus the shock is absorbed and relieved.

Furthermore, the other end of the damping shaft 132 is elastically supported by an elastic spring 133 disposed in the cylinder 131a. Therefore, when pressure applied to the contact surface 132a is released, the damping shaft 132 is returned to its original position by restoring force of the elastic spring 133.

Until now, an example in which the damping shaft 132 carries out the damping operation using the oil pressure is described, but the present invention is not limited to the example. If it is possible to facilely absorb the shock generated when the window 120 is closed, the damping shaft 132 may have other structure in which the damping operation is performed using air pressure or elastic force of a spring.

Meanwhile, a protrusion 131c may be further provided at a lower surface of the damper body 131 so as to be inserted and settled in a coupling groove 111 formed in the window frame 110.

It is all right that only one damper 130 is provided at one side of the window frame 130. Preferably, the damper 130 is symmetrically provided at both sides of the window frame 110 in order to efficiently absorb the shock.

And a gasket 140 formed of a soft rubber or silicon material is provided at a surface of the window 120, which is contacted with the window frame 110, so as to maintain the air-tightness between the window frame 110 and the window 120. Preferably, the gasket 140 is located to be contacted with the contact surface 132a of the damping shaft 132 when the window 120 is closed on the window frame 110. Therefore, it is possible to minimize the shock generated when the window 120 is strongly collided with the contact surface 132a of the damping shaft 132.

Further, the contact surface 132a of the damping shaft 132 may be formed of a soft rubber or silicon material. Of course, the present invention is not limited to this. Any structure and material which can absorb the shock can be applied.

FIG. 4 is a cross-sectional view showing that a window is closed in the T-T window system having a damper according to the present invention.

Referring to FIG. 4, in the T-T window 100 having a damper according to the present invention, as described above, when the window 120 is rapidly closed by high wind pressure, it is possible to absorb and relieve the shock generated when one surface of the window 120 is contacted with the contact surface 132a of the damping shaft 132. At this time, the contact surface 132a of the damping shaft 132 is contacted with the gasket 140 disposed at the window 120, and thus it is possible to minimize the shock.

Therefore, it is prevented that each of the corner portion of the window frame 110 is damaged, and also it is possible to secure the durability of the T-T window.

### INDUSTRIAL APPLICABILITY

According to the present invention, since the T-T window system having a damper can absorb and relieve the shock generated when the window is closed on the window frame, it is possible to prevent each corner portion of the window frame from being damaged and thus to secure the safety.

Further, since the T-T window system having a damper absorbs and relieves the shock generated when the window is closed on the window frame, it is possible to secure durability of the window system.

While the present invention has been described with respect to the specific embodiments, it will be apparent to those skilled in the art that various changes and modifications may be made without departing from the spirit and scope of the invention as defined in the following claims.

1. A T-T (Tilt & Turn) window system having a damper, comprising:
a window frame;
a window which is coupled to the window frame so as to be closed and opened in a T-T manner; and
a damper which is disposed at at least one side of the window frame so as to be contacted with a surface of the window.

2. The T-T window system according to claim 1, wherein the damper comprises:
a damper body in which a cylinder is provided at one side thereof;
a damping shaft which is slidably inserted into the cylinder and of which exposed one end is formed with a contact surface; and
an elastic spring which is disposed in the cylinder so as to elastically support the other end of the damping shaft.

3. The T-T window system according to claim 2, wherein the damper body has a plurality of installation holes, and also the damper body is installed at one side of the window frame through a coupling member inserted into the installation hole.

4. The T-T window system according to claim 2, wherein the damping shaft carries out a damping operation using oil pressure generated by sliding of the damping shaft.

5. The T-T window system according to claim 4, wherein a gasket is provided at a surface of the window, which is contacted with the window frame, and the gasket is contacted with a contact surface of the damping shaft when the window is closed on the window frame.

6. The T-T window system according to claim 4, wherein the contact surface of the damping shaft is formed of a soft rubber or silicon material.

7. The T-T window system according to claim 4, wherein a protrusion is further provided at a lower surface of the damper body so as to be fixedly inserted and settled in a coupling groove formed in the window frame.

8. The T-T window system according to claim 3, wherein the damping shaft carries out a damping operation using oil pressure generated by sliding of the damping shaft.

9. The T-T window system according to claim 8, wherein a gasket is provided at a surface of the window, which is contacted with the window frame, and the gasket is contacted with a contact surface of the damping shaft when the window is closed on the window frame.

10. The T-T window system according to claim 8, wherein the contact surface of the damping shaft is formed of a soft rubber or silicon material.

11. The T-T window system according to claim 8, wherein a protrusion is further provided at a lower surface of the damper body so as to be fixedly inserted and settled in a coupling groove formed in the window frame.
